(19) United States
(12) Patent Application Publication
(10) Pub. No.: US 2026/0217450 A1
(43) Pub. Date: Jul. 30, 2026

(54) DEVICES, SYSTEMS, AND METHODS FOR COLLECTING LEACHATE FROM A COMPOSTING CONTAINER

(71) Applicant: Timothy G. Shuttleworth, Fairview, PA (US)

(72) Inventor: Timothy G. Shuttleworth, Fairview, PA (US)

(21) Appl. No.: 19/459,348

(22) Filed: Jan. 26, 2026

Related U.S. Application Data
(60) Provisional application No. 63/749,501, filed on Jan. 25, 2025.

(51) Int. Cl. B65F 1/14

(52) U.S. Cl. CPC B65F 1/14; B65F 2001/1489

(57) ABSTRACT

A system for collecting leachate can include a leachate trap positioned under the base of a container to receive fluid flowing through a gap in the container. The leachate trap can comprise a tray, a grate extending over the tray, and a sump fluidically coupled to the tray. The container can be a roll-off dumpster including a base and a door, wherein a gap is defined between the door and the base. A method for collecting leachate can include positioning a mobile leachate trap under a portion, such as a door end portion, of a roll-off dumpster serving as a composting container.

### CROSS-REFERENCE TO RELATED APPLICATION

The present application claims the benefit under 35 U.S.C. § 119(e) of U.S. Provisional Ser. No. 63/749,501 , filed Jan. 25, 2025, titled DEVICES, SYSTEMS, AND METHODS FOR COLLECTING LEACHATE FROM A COMPOSTING CONTAINER, which is incorporated by reference herein in its entirety.

### BACKGROUND

Composting of organics often generates a liquid discharge or by-product called leachate. Generally, it is desirable to prevent leachate and naturally-occurring precipitation, e.g. “clean” rainwater and snowmelt, from mixing.

### SUMMARY

One general aspect includes a mobile leachate trap for use with a composting container, wherein the mobile leachate trap includes a tray including a first end, a second end positioned opposite to the first end, a bottom wall extending from the first end to the second end, and an open top opposite to the bottom wall. The trap also includes a plurality of upright walls extending from the bottom wall to enclose a leachate receptacle, and a grate spaced apart from the bottom wall to at least partially enclose the leachate receptacle. The mobile leachate trap can further include a sump fluidically coupled to the tray at the first end.

One general aspect includes a system for collecting leachate. The system includes a roll-off container having a base and a door, wherein a gap is defined between the door and the base. The system also includes a leachate trap positioned under the base to receive fluid flowing through the gap, wherein the leachate trap may include a tray, a grate extending over the tray, and a sump fluidically coupled to the tray.

One general aspect includes a method for collecting leachate. The method includes positioning a mobile leachate trap relative to a composting container, where the mobile leachate trap includes a tray, a grate, and a sump. The method also includes pumping the leachate from the sump to a storage container.

### BRIEF DESCRIPTION OF THE FIGURES

Various features of the embodiments described herein, together with advantages thereof, may be understood in accordance with the following description taken in conjunction with the accompanying drawings as follows:

FIG. 1 depicts exemplary roll-off containers, according to various aspects of the present disclosure.

FIG. 2 is a flowchart depicting composting cycles, according to various aspects of the present disclosure.

FIG. 3 is a perspective view of a system including a portion of a roll-off container in combination with a mobile leachate trap, according to various aspects of the present disclosure.

FIG. 4 is a perspective view of part of the system of FIG. 3, including the sump, according to various aspects of the present disclosure.

FIG. 5A is a perspective view of the mobile leachate trap of FIG. 3, according to various aspects of the present disclosure.

FIG. 5B is a top view of a portion of the mobile leachate trap of FIG. 3, according to various aspects of the present disclosure.

FIG. 6 is a front, cross-sectional view of the sump of FIG. 4, according to various aspects of the present disclosure.

FIG. 7 is a flow diagram depicting a method for collecting leachate from a roll-off container, according to various aspects of the present disclosure.

### DETAILED DESCRIPTION

Roll-off waste containers, or similar dumpster containers, are used extensively in the waste management industry. Similarly, intermodal containers are used extensively in the transportation industry. Roll-off waste containers, dumpster, and intermodal shipping containers are readily available and can often be obtained at a relatively low-cost. Such containers can be utilized in a variety of industries, including agriculture and farming, for example. For example, secondhand containers can be repurposed for alternative purposes, such as composting, for example, as further described herein.

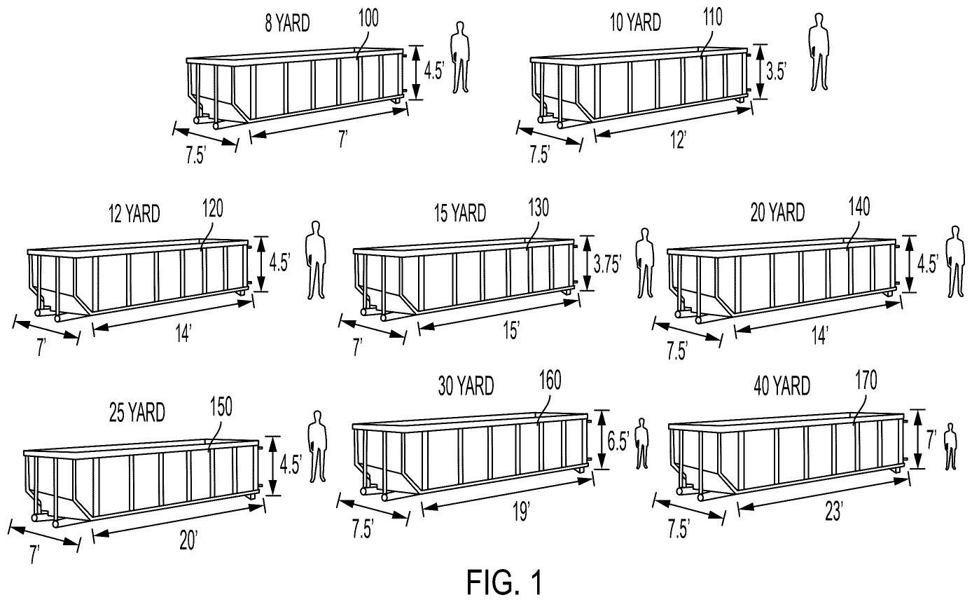

Exemplary open-top roll-off containers are shown in FIG. 1. For example, FIG. 1 depicts an 8 cubic-yard container 100, a 10 cubic-yard container 110, a 12 cubic-yard container 120, a 15 cubic-yard container 130, a 20 cubic-yard container 140, a 25 cubic-yard container 150, a 30 cubic-yard container 160, and a 40 cubic-yard container 170. Alternative size and geometry containers having a substantially cuboid shape, which may be readily available in certain geographic areas, are also contemplated.

Each container 100, 110, 120, 130, 140, 150, 160, and 170 includes a floor, four sides, and an open top. A door is positioned on one of the four sides for each container 100, 110, 120, 130, 140, 150, 160, and 170. The doors can form one entire side of each container 100, 110, 120, 130, 140, 150, 160, and 170, respectively. In other instances, the doors can form a portion of a side wall. The doors open along upright, vertically-spaced hinges; however, other door opening arrangements (e.g. sliding, folding, etc.) are envisioned.

The footprint and geometry of the containers 100, 110, 120, 130, 140, 150, 160, and 170 is configured to fit the container onto the bed of a truck or other vehicle for transportation and/or unloading (e.g. dumping of the contents therefrom).

The containers and similarly-shaped cuboid containers can be used with the various ramp systems and loading/unloading methods described herein. However, the reader will readily appreciate that the various ramp systems and loading/unloading methods described herein can be used in connection with other containers as well.

In various instances, raw material can be composted in a container, such as in a commercially-available, roll-off waste container (see, e.g. FIG. 1), dumpster, or open-top intermodal shipping container. In various instances, these containers can be utilized for composting without permanent modifications being made thereto, which can be economically advantageous, for example.

In certain instances, aeration of raw material that is loaded into a container for composting can be provided by a ductwork system including conduits, pipes, tubes, or ducts that enter the container through the open-top and are arranged along a solid floor of the container. The ductwork system can be installed and maintained in position without modifying the container. For example, the solid walls and the floor, or bottom surface, of the containers 100, 110, 120, 130, 140, 150, 160, and 170 can remain unchanged, e.g., free of additional screw holes, slits, or other openings. Container-based composting is further described in U.S. Pat. No. 11,111,188, titled CONTAINER-BASED COMPOSTING, which issued Sep. 7, 2021; U.S. patent application Ser. No. 18/381,495, titled COUPLINGS FOR CONTAINER-BASED COMPOSTING, which published as US2024/0124369 on Apr. 18, 2024; U.S. patent application Ser. No. 18/628,175, titled RAMP ASSEMBLY KIT FOR A CONTAINER, which published as US2024/0336448 on Oct. 10, 2024; and U.S. Provisional Patent Application No. 63/942,063, titled IN-VESSEL COMPOSTING SYSTEM WITH INTEGRATED BIOFILTER, filed Dec. 16, 2025. U.S. Pat. No. 11,111,188, U.S. patent application Ser. No. 18/381,495, U.S. patent application Ser. No. 18/628,175, and U.S. Provisional Patent Application No. 63/942,063 are all incorporated by reference herein in their respective entireties.

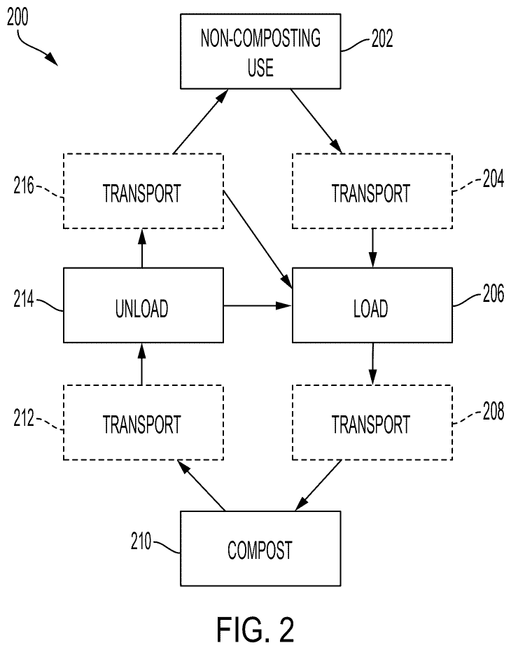

Referring primarily to FIG. 2, a flowchart 201 depicting exemplary composting sequences is depicted. Initially, the container for a composting system can be engaged in a non-composting use at block 202. The container can then be repurposed for composting. For example, the container can be loaded with the additional components of the composting system and with raw material at block 206. The various ramp systems disclosed herein can be utilized for loading the raw material at block 206. Optionally, the container can be relocated at block 204. For example, the container alone or the container in combination with the additional components for the composting system can be leased from a lessor and delivered to the lessee. After the container is loaded at block 206, the composting cycle can be completed at block 210. Optionally, the container can be relocated at block 208 between loading and composting. For example, the container can be transported to a different location on the lessee's property, the lessor's property, and/or a third party's property. Upon completion of the composting cycle, the container can be unloaded at block 214. In certain instances, the compost can be unloaded. Additionally or alternatively, the components of the composting system (e.g. aeration distributors) can be unloaded. If the container is being returned to a non-composting use at block 202, the additional components should be removed therefrom. Alternatively, if the container is ready for receipt of additional raw material, the additional components may remain in the container and it can again be loaded with raw material at block 206. Optionally, the container can be relocated at block 212 between composting and unloading. For example, the composted material can be sold to a third party and/or returned to the lessor within the container at block 212. After the container is unloaded, it can be transported at block 216 to a new site (e.g. a new lessee) at block 206 and/or to a non-composting use at block 202.

The reader will appreciate that the flowchart described above with respect to FIG. 2 can apply to the containers in FIG. 1, to multiple containers and/or to different sized containers. The container is filled with raw material at block 206 and transformed compost is unloaded at block 214. A lessor of the container and/or composting system can then distribute the composted material and relocate the container to minimize expenses and maximize profits. For example, the composted material can easily be transported to regions having a high demand for compost before it is relocated or delivered to another lessee. In various instances, composting at block 210 can occur during a portion of a transportation route to maximize use of the container during the composting cycle. In such instances, the container can serve dual purposes as a composting vessel and shipping or transportation container.

Leachate generated during a composting cycle is a nutrient rich effluent, which is often dark in color. Leachate should be managed to avoid release into the environment and public waterways. A general rule is to prevent “clean” rainwater or snow melt water from entering the effluent leachate stream and prevent the effluent leachate stream from contaminating the “clean” rain and snow melt waterways.

Containerized composting provides control over the composting environment and the composting by-products, including any leachate generated during the composting cycle, for example.

One vessel in use for in-vessel composting is a commercial roll-off dumpster of various sizes and types, as further described herein. These commonly have one operative door. In other instances, commercial roll-off dumpsters have two or more operative doors through which materials and composting apparatus are moved. These doors, hinging on one or two vertical sides, usually have no liquid seal. As a result, the containers are intended for containing only solids and finished compost when used for composting. New and well-maintained but used roll-off dumpster containers generally have no other liquid/gravity discharge point other than the container's doorway. These in-vessel composters are often used in the open elements without shelter from rain and snow.

A leachate trap, as further disclosed herein, can facilitate and trap leachate at the roll-off dumpster's doorway while avoiding the collection of naturally-occurring precipitation within the leachate trap, for example.

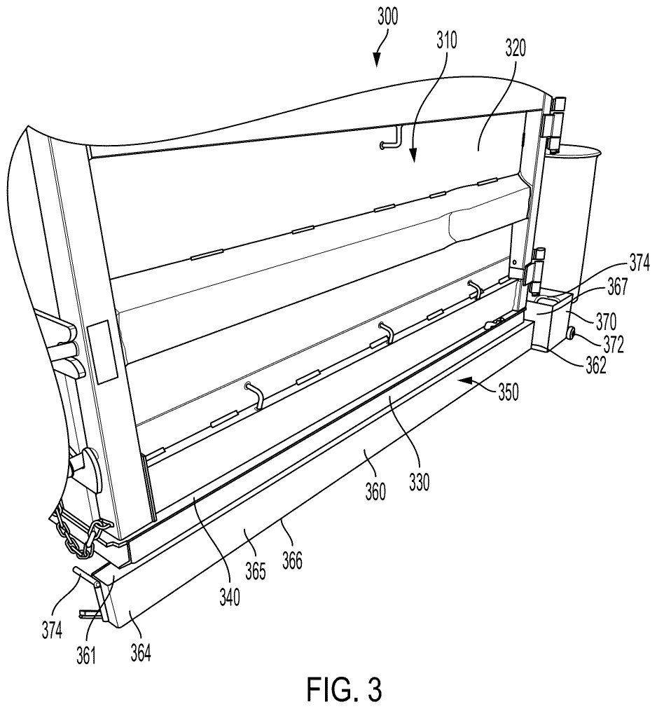

Referring now to FIG. 3, a system 300 for collecting leachate is depicted. The system includes a roll-off container 310 and a mobile leachate trap 350. The roll-off container 310 features a door 320 and a base 330. The door 320 and the base 330 create a gap 340. The gap 340 is not liquid tight, which allows for leachate to escape, e.g. flow, through the gap 340 toward the ground. However, the mobile leachate trap 350 is positioned relative to the door-side of the roll-off container 310 to capture drips of escaping leachate.

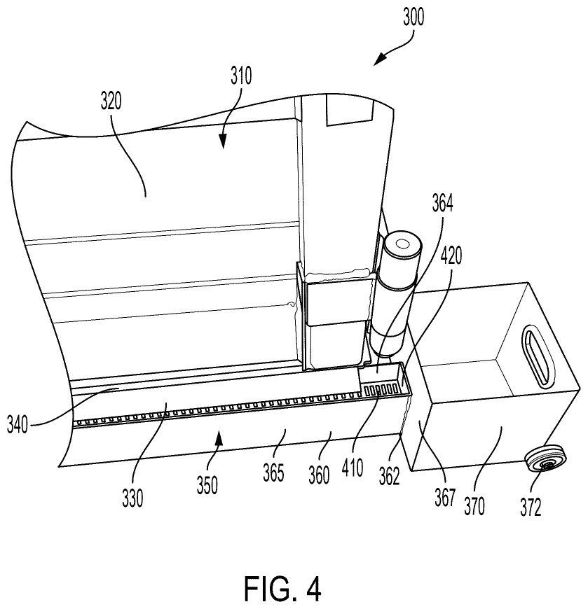

The mobile leachate trap 350 includes a tray 360, a grate 410 (FIG. 4), and a sump 370. The tray 360 includes a first end 361 and a second end 362. The tray 360 is sized to fit under the container 310. Stated differently, the maximum height of the tray 360 allows it to be placed on the ground supporting the roll-off container 310 and below the roll-of container 310.

The tray 360 further include an open top 364, a plurality of side walls, or upright walls, 365, and a bottom wall 366, creating a leachate enclosure. The side walls 365 extend from the bottom wall 366 to enclose the leachate receptacle. The grate 410 is spaced apart from the bottom wall to at least partially enclose the leachate receptacle. In various instances, the grate 410 is spaced approximately halfway between the top and the bottom edge of the tray 360. The sump 370 is fluidically coupled to the tray 360. The leachate enclosure comprises a liquid-tight lower portion for holding the leachate therein. At the first end 361 of the tray 360, a handle 374 is attached to the plurality of side walls 365. At the second end 362 of the tray 360, a first wall 367 is defined within the plurality of side walls 365. The sump 370 is attached to the tray 360 at the first wall 367.

In various aspects, the grate 410 is held in place by gravitational forces. Utilizing gravitational forces can allow the grate to be easily removed from the tray 360 for cleanout and maintenance. In some non-limiting examples, the grate 410 may further be supported by feet attached to the bottom of the grate, supports extending vertically from the bottom wall 366 to support the bottom of the grate, a tapered edge on the plurality of sidewalls 365 allowing the grate 410 to be held in place by friction forces, a ledge along the perimeter of the plurality of sidewalls 365 that the grate 410 is dimensioned to sit upon, or any combination thereof.

According to various embodiments of the present disclosure, the mobile leachate trap may feature various elements to increase mobility. These features may include the addition of wheels and handles. For example, the sump 370 includes a wheel 372 and a handle 374. In various aspects, the sump 370 and/or the tray 360 can include one or more wheels, which can be supported on an axle. In certain instances, the mobile leachate trap 350 includes a wheel or wheels at one end and the other end is lifted like a wheelbarrow to roll the mobile leachate trap 350 along the wheel(s). Although the wheel 372 is shown attached to the sump 370 herein, in other aspects of the present disclosure, a wheel can be additionally or alternatively attached to the tray 360. In various aspects, the wheel can be positioned at and/or adjacent to the sump 370 and, in other aspects, can be positioned at and/or adjacent to the opposite end of the tray 360 from the sump 370.

In various instances, the mobile leachate trap 350 can include one or more handles. For example, handles may be positioned on opposite ends of the leachate trap. There may be a handle at the first end of the tray, allowing for ease in pulling the trap while using the wheels. The sump may also include a handle for ease in lifting the device.

Referring now to FIG. 4, part of the system 300 is shown. The container 310 includes the door 320, the base 330, and the gap 340 created between the door 320 and the base 330. Further, the mobile leachate trap 350 is depicted. An opening 420 is defined in the first wall 367 that fluidically connect the tray 360 to the sump 370, allowing for the passage of leachate from the tray 360 into the sump 370.

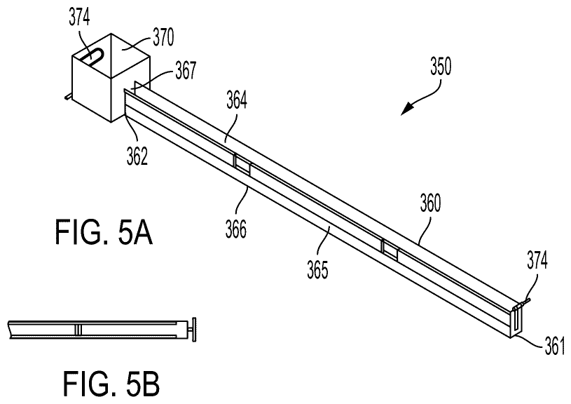

Referring now to FIG. 5, a perspective view of the leachate trap 350 is shown. A handle 374 is attached to the first end 361 of the tray 360 to increase mobility (e.g. to lift one end and facilitate rolling of the tray 360 along the ground at the wheel 372). As shown in FIG. 5, the tray 360 can include one or more windows or openings along the length thereof (two are shown in FIG. 5), which can be adapted to accommodate the geometry of the container 310. For example, roll-off dumpsters generally include runners along the underside thereof, which extend adjacent and/or under a portion of the door of the container 310, and nest with a truck for relocation and/or lifting of the container 310. The windows along the sidewall of the tray 360 can be keyed to align with the runners. A soft membrane, such as a rubber gasket, can be provided to fill the windows during use. For example, the soft membrane can be friction-fit and/or interference fit with the windows, and/or can be popped in and out of the windows by an operator. In such instances, the trap 350 can be filled higher with leachate (and thus the sump 370 can be filled higher between pump-out sessions). In various instances, the soft membrane can direct fluid from the runner(s) away from the tray 360, for example.

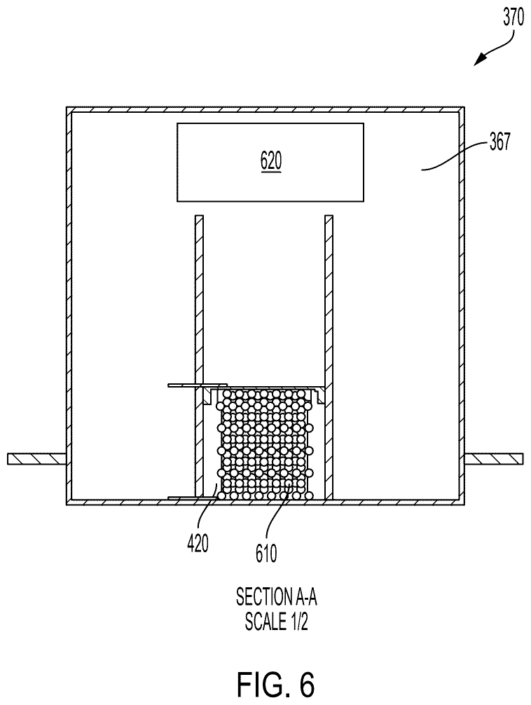

Referring now to FIG. 6, a schematic of the sump 370 is shown. The opening 420 in the first wall 367 continues through the sump 370, fluidically coupling the sump 370 to the tray 360. An upright, or vertical, grate 610 is shown across the opening 420 in the first wall 367. In various instances, the upright grate 610 creates a second layer of filtering to ensure material does not mix with the leachate. In various instances, the upright grate 610 is structured to catch smaller or finer particles than the grate 410. In some non-limiting examples, the upright grate 610 can be held in place by notches in the bottom wall 366 and the grate 410 that the upright grate 610 can interact with, permanently attached to the first wall, supported by feet extending outwardly from the upright grate 610 to keep it upright, fit within a slot in the first wall, or any combination thereof.

According to various embodiments of the present disclosure, the sump 370 may include a drain. In some non-limiting examples, the drain may be on the bottom of the sump, or on walls of the sump, or a combination of both. In one non-limiting example, the drain may be an overflow drain to ensure the sump 370 does not fill with leachate beyond a certain point. In some embodiments, the drain may include a removable plug that is configured to prevent the flow of leachate out of the sump 370.

In various instances, the sump 370 may further include a pump 620 configured to pump the leachate out of the sump 370. The sump may feature a removable lid sized to fit across an open top of the sump. The removable lid would further present contamination of leachate with other materials. The pump can pump leachate to a secondary holding container, like a tank or a barrel, to a sanitary septic line, and/or to another dumpster, for example.

In various aspects, the plurality of sidewalls 365 may include a first wall adjacent to the sump 370. The opening 420 can be defined in the first wall to fluidically couple the leachate receptable of the tray 360 to the sump 370. This opening 420 may have a top edge positioned between the bottom wall 366 and the grate 410 such that material caught by the grate 410 cannot pass through the opening 420 positioned under the grate 410.

According to various embodiments of the present disclosure, the mobile leachate trap 350 may include various features to increase durability. These feature may include a rubber lining positioned within at least one of the tray and the sump. These features may also include a corrosion resistant coating applied to at least one of the tray and the sump.

According to various embodiments of the present disclosure, the tray 360 may be oriented at an angle (e.g. sloped) relative to (and toward) the sump 370 to increase a rate of flow of the leachate toward the sump 370.

According to various embodiments of the present disclosure, the roll-off container 310 may be a dumpster.

In various instances, the tray 360 defines a horizontal area or zone that matches or slightly exceeds the roll-off container 310's doorway zone, or width.

According to various embodiments of the present disclosure, a non-mobile leachate trap may be used in the system. In this instance, the leachate trap would be built into a concrete pad positioned under a composting container. In such instances, to collect leachate without contamination by and/or of precipitation, the concrete pad can be sloped downward from the leachate trap. In other words, the grate of the leachate trap can be positioned higher than the surrounding concrete. In such instances, rain, run-off, etc. would not flow into the leachate trap, but rather, away from the leachate trap.

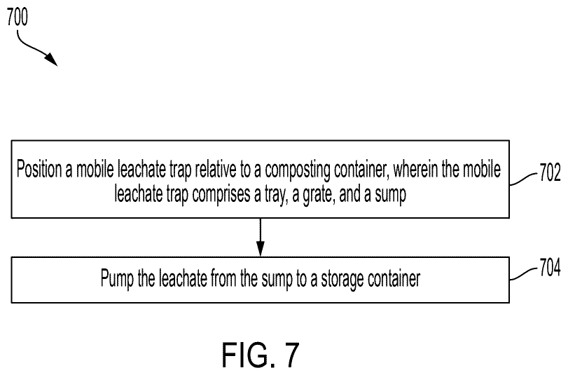

Referring now to FIG. 7, a flow chart depicting a leachate collecting method 800 is shown. The method 800 can be employed with the mobile leachate trap 350 and/or the container 310, for example. The method 800 includes positioning 802 a mobile leachate trap relative to a composting container, wherein the mobile leachate trap comprises a tray, a grate, and a sump. The method 800 further includes pumping 804 the leachate from the sump to a storage container.

The method 800 may further include pulling the mobile leachate trap by a handle to position the mobile leachate trap under a gap defined between a door and a base of the composting container, rolling the mobile leachate trap along a plurality of wheels of the mobile leachate trap, positioning the tray to extend laterally beyond a first longitudinal side of the container and a second longitudinal side of the container, passing leachate through the grate into the tray and collecting leachate flowing from the tray into the sump, or any combination thereof.

According to various embodiments of the present disclosure, various elements of the tray may be designed to maximize the collection of leachate while ensuring excess material does not mix with the final collection of leachate in the sump. These features may include the tray extending below the door of the container. This may be designed such that the tray is adjacent to the gap of the container to ensure the tray receives leachate from the container. This may further include a narrow tray, configured such that the tray does not extend beyond a front edge of the door of the container. In this instance, the door will act as a further shield to prevent material from entering the tray, such as impure snow and rain or various types of debris. In further embodiments, the tray may extend laterally beyond a first longitudinal side of the container and a second longitudinal side of the container. This minimum length of the tray minimizes the chances of leachate exiting the container without entering the tray.

In various instances, a mobile leachate trap, which is detachable from the composting container itself, allows a composting site to have fewer mobile leachate traps than composting dumpsters. For example, in various instances, not all composting dumpsters are actively composting/producing leachate at the same time.

One or more components may be described as “configured to,” “configurable to,” “operable/operative to,” “adapted/adaptable to,” or similar terms. Unless explicitly stated, these terms encompass components in both active and inactive states. Unless stated otherwise, terms like “including” or “having” should be interpreted as open-ended (i.e., “including but not limited to”). Numeric claim recitations generally mean “at least” the stated number, and disjunctive terms like “A or B” should be interpreted to include either or both unless explicitly specified. Operations in any claim may generally be performed in any order unless explicitly stated. The recitation “at least one of A, B, and C” should be interpreted as any combination of A, B, and C, such A alone, B alone, C alone, A and B together, A and C together, B and C together, and/or A, B, and C together. The recitation “at least one of A, B, or C” should be interpreted to include A alone, B alone, C alone, A and B together, A and C together, B and C together, and/or A, B, and C together.

This written description may disclose several embodiments of the subject matter, including the best mode, and may enable one of ordinary skill in the relevant art to practice the embodiments of subject matter, including making and using any devices or systems and performing any incorporated methods. The patentable scope of the subject matter is defined by the claims, and may include other embodiments that may occur to one of ordinary skill in the art. Such other embodiments may be intended to be within the scope of the claims if they may have structural elements that may not differ from the literal language of the claims, or if they may include equivalent structural elements with insubstantial differences from the literal languages of the claims.

What is claimed is:

1. A mobile leachate trap for use with a composting container, the mobile leachate trap comprising:
a tray, comprising:
a first end;
a second end positioned opposite to the first end;
a bottom wall extending from the first end to the second end;
an open top opposite to the bottom wall; and
a plurality of upright walls extending from the bottom wall to enclose a leachate receptacle; and
a grate spaced apart from the bottom wall to at least partially enclose the leachate receptacle; and
a sump fluidically coupled to the tray at the first end.

2. The mobile leachate trap of claim 1, wherein the grate is held in place by gravitational forces.

3. The mobile leachate trap of claim 1, wherein the plurality of upright walls comprises a first wall adjacent to the sump, wherein an opening is defined through the first wall, wherein the opening fluidically couples the leachate receptacle to the sump, and wherein the opening comprises a top edge positioned between the bottom wall and the grate such that material caught by the grate cannot pass through the opening.

4. The mobile leachate trap of claim 3, further comprising an upright grate positioned within the tray, wherein the upright grate extends over the opening.

5. The mobile leachate trap of claim 1, wherein the sump further comprises a drain.

6. The mobile leachate trap of claim 5, wherein the drain further comprises a removable plug that is configured to prevent the flow of leachate out of the sump.

7. The mobile leachate trap of claim 1, further comprising a pump positioned within the sump, wherein the pump is configured to pump the leachate out of the sump.

8. The mobile leachate trap of claim 1, further comprising a removable lid sized to fit across an open top of the sump.

9. The mobile leachate trap of claim 1, further comprising a wheel and structure to roll over the ground to move the sump and the tray.

10. The mobile leachate trap of claim 1, further comprising a handle at the second end of the tray.

11. The mobile leachate trap of claim 1, further comprising a rubber lining positioned within at least one of the tray and the sump.

12. The mobile leachate trap of claim 1, wherein a corrosion resistant coating is applied to at least one of the tray and the sump.

13. A system for collecting leachate, the system comprising:
a roll-off container, comprising:
a base; and
a door, wherein a gap is defined between the door and the base; and
a leachate trap positioned under the base to receive fluid flowing through the gap, wherein the leachate trap comprises a tray, a grate extending over the tray, and a sump fluidically coupled to the tray.

14. The system of claim 13, wherein the tray extends below the door of the roll-off container.

15. The system of claim 13, wherein the tray extends laterally beyond a first longitudinal side of the roll-off container and a second longitudinal side of the roll-off container.

16. The system of claim 13, wherein the tray is oriented at an angle relative to the sump to increase a rate of flow of the leachate toward the sump.

17. The system of claim 13, wherein the roll-off container comprises a dumpster.

18. A method for collecting leachate, the method comprising:
positioning a mobile leachate trap relative to a composting container, wherein the mobile leachate trap comprises a tray, a grate, and a sump; and
pumping the leachate from the sump to a storage container.

19. The method of claim 18, wherein positioning the mobile leachate trap relative to the composting container further comprises pulling the mobile leachate trap by a handle to position the mobile leachate trap under a gap defined between a door and a base of the composting container.

20. The method of claim 18, wherein positioning the mobile leachate trap relative to the composting container further comprises rolling the mobile leachate trap along a plurality of wheels of the mobile leachate trap and positioning the tray to extend laterally beyond a first longitudinal side of the container and a second longitudinal side of the container, and wherein the method further comprises:
passing leachate through the grate into the tray; and
collecting leachate flowing from the tray into the sump.
